(19) United States
(12) Patent Application Publication
(10) Pub. No.: US 2006/0185078 A1
(43) Pub. Date: Aug. 24, 2006

(54) Patient turning aid

(76) Inventor: Barbara L. Perry, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/357,830

(22) Filed: Feb. 17, 2006

Related U.S. Application Data
(60) Provisional application No. 60/654,785, filed on Feb. 19, 2005.

(51) Int. Cl. A61G 7/10

(52) U.S. Cl. 5/81.1 T

(57) ABSTRACT

A patient turning aid for assisting a health care assistant in turning, pivoting, raising or otherwise moving a patient while he or she is laying in a bed having one or more side rails, such as those commonly used in hospitals and other medical facilities. The patient turning aid has a main body panel configured to be placed under the patient and one or more elongated extension members extending outwardly from each end of the main body panel. The distal ends of the extension members loop around one or more side rails to secure the extension members to the side rails by connecting mechanisms on the extension members to hold the patient in the moved position. In the preferred embodiment, the main body member comprises an absorbent layer of material on the upper surface and a fluid impermeable layer of material on the lower surface of the main body panel.

### CROSS-REFERENCE TO RELATED APPLICATIONS

This application claims the benefit of U.S. Provisional Application No. 60/654,785 filed on Feb. 19, 2005.

### BACKGROUND OF THE INVENTION

A. Field of the Invention

The field of the present invention relates generally to health aid devices and apparatuses that are configured to assist health care professionals and other health care assistants with providing care to patients. In particular, the present invention relates to such devices and apparatuses that are configured to assist health care assistants with turning, partially lifting and positioning patients who are substantially bedridden. Even more particularly, this invention relates to devices and apparatuses that can be used by a single health care assistant to pivot, rotate or otherwise move a patient in the bed and then support the patient in that position while the assistant changes bandages, clothing or bedding and/or provides assistance to the patient.

B. Background

As is well known in the health care industry and by those who care for sick or injured persons, many such patients are completely or substantially bedridden due to their inability to move or the level of discomfort associated with moving off of the bed. Despite, and even to some extent because of, being bedridden, these patients need a substantial amount of care that requires the patient to be moved to provide that care. It is well known that health care assistants, which includes health care professionals such as doctors, nurses and nursing aids, and other health care providers such as nursing aid workers and family members, are often required to move a bedridden patient in order to have access to the parts of his or her body that are lying on the bed and to the bedding materials themselves. For instance, the health care assistant may need to check on the healing progress of an injury or wound, change a bandage, apply lotions or medications and perform a variety of other tasks on the bedridden patient's back and backside area. In addition, a health care assistant may need to move a patient so that he or she can change the patient's clothes and/or change the bedding under the patient. The health care assistant may also need to move a bedridden patient to wash the patient's hair or otherwise assist the patient.

Very often it is beneficial or necessary for the foregoing and other health care tasks that the patient be held in a rotated, pivoted or raised position while the health care assistant provides the desired care. For instance, in order to change a bandage or apply medicine to the backside of a patient it is generally necessary to pivot the patient onto his or her side and hold the patient in that position while the bandages are changed or medicine is applied. The natural tendency for a patient pivoted in this manner is for the patient to roll back onto his or her backside. When it is desired or necessary to wash a patient's hair, the task generally requires the upper torso area of the patient's body to be raised off of the bed so that the health care assistant can have easier and fuller access to the patient's hair so it can be effectively washed. The natural tendency in this instance, and for the bedridden patient generally, is for the patient's body to want to lie flat against the bed. As a result, the health care assistant(s) attempting to perform these tasks must first pivot, raise or otherwise move the patient and then maintain the patient in that position while fighting the natural forces trying to move the patient back to the flat, bed-supported position.

As those in the health care industry and others who provide care to bedridden persons know, it is very difficult for a single health care assistant to move the patient to the desired position and then hold the patient in that position while attempting to simultaneously accomplish the desired health care task. In fact, depending on the size, weight and condition of the patient, it can be very difficult for the health care assistant just to move the patient into the desired position. Attempting to move a patient, particularly a large or otherwise difficult to move patient, and then holding the patient in that position while performing the desired health care task can, and often does, result in injury to the health care assistant or patient. In particular, it is well known that health care assistants are subject to back and other injuries as a result of such activities.

One way to reduce the likelihood of injury to the health care assistant and/or the patient is for more than one health care assistant to work together to move and hold the patient so that the care may be provided. Utilizing two or more health care assistants, for instance a nurse and a family member, solves the problem of how to gently rotate or lift the patient and then hold the patient in the rotated or lifted position while bandages, clothes or bedding are changed, medicine or lotion is applied or other care activities are undertaken. The use of multiple health care assistants, however, is not always efficient, feasible and/or possible. It is well known that hospitals and nursing homes generally do not have sufficient nursing or related staff to enable two or more personnel to participate whenever it is necessary or desirable to move or hold the patient. Even in those hospitals or nursing home environments that do not have a shortage of nursing staff, the use of multiple personnel to accomplish the tasks of pivoting, rotating, raising or otherwise moving a patient is generally not an efficient use of these highly trained staff. For patients who are bedridden in a home care environment, there is typically not more than one professional health care provider, such as a visiting nurse, in the home during the periods when movement of the patient is necessary or desirable. Although a family member or other person may assist the health care professional, the timing or availability of such help is not always predictable. For those family members who take care of a bedridden family member themselves, assistance is often not available.

As a result of the difficulties, inefficiencies and costs associated with having more than one health care assistant to move and hold the patient during the aforementioned and related health care tasks, generally a single person must move and maintain the position of the patient while performing those tasks. As a result, injuries to health care assistants and, to some extent, to the patients themselves continues to a major problem. Even when injury is not a problem, the difficulties and time associated with performing these tasks can reduce the likelihood that they will be performed.

Over the years, a number of devices for helping a health care assistant move a bedridden patient have been patented. For instance, U.S. Pat. No. 1,334,901 to Higdon discloses a turning sheet and pad having a base member of stiff, strong sheet on which an absorbent pad is placed. In use, the health care assistant grabs one end of the sheet to turn the patient over. U.S. Pat. No. 3,884,225 to Witter discloses a bed patient turn and hold device having a thin and flexible sheet with straps at each end and a fleece cushion attached to the sheet midway between the ends of the sheet. Snap elements or hook members are utilized to attach the straps to a bed side rail. U.S. Pat. No. 4,180,879 to Mann discloses a body positioner having a contoured body sheet with fastening straps extending from the sheet that uses hook and loop material (i.e., Velcro® and snap connectors to attach to bed side rails to support a patient while he or she sleeps. U.S. Pat. No. 4,536,903 to Parker discloses a device for manipulating invalid bed patients having a sheet of porous materials with a central panel and complimentary end panels extending outward from the central panel. A hand grip mechanism, which can include a handle received in a tubular portion of each of the end panels, is utilized for manipulating the sheet and a patient lying on top of the sheet. Straps extend outward from the handles and engage bed side rails with a fastening mechanism such as Velcro®. U.S. Pat. No. 4,675,925 to Littleton discloses a device for manipulating bedridden patients having a sheet with an absorbent pad affixed thereto with handles and tie straps on the lateral edges of the sheet. U.S. Pat. No. 6,560,793 to Walker discloses a patient repositioning and care device having a draw sheet with lateral sleeves for placement of gripping dowels inside that are used for the attendant to rotate the patient. Elongated body straps having fasteners, such as Velcro® at the ends are used to attach to the side rails of a bed.

Despite the aforementioned and other prior art, use of devices to assist a person with moving a bedridden patient are not widely available. What is needed, therefore, is an improved device or apparatus for moving and holding a bedridden patient. The improved device or apparatus should allow a health care assistant to rotate, pivot, raise or otherwise move the patient into a desired care treating position and then hold the patient in that position while the health care provider provides the desired care. The preferred device should improve the efficiency of providing such care and reduce the likelihood that the patient or health care assistant will be injured while providing the desired care. The preferred device should be easy to use and relatively inexpensive to manufacture so as to be more readily available.

### SUMMARY OF THE INVENTION

The patient turning aid of the present invention provides the benefits and solves the problems identified above. That is to say, the present invention discloses a patient turning aid that allows a single health care assistant, whether a professional health care provider, family member or other person, to rotate, pivot, raise or otherwise move a patient and hold the patient in a desired position. As such, the patient turning aid of the present invention will provide improved health care efficiency and reduce the likelihood that either or both the health care assistant or patient will be injured while moving or holding a bedridden patient. The patient turning aid of the present invention is easy to use, effective at moving and holding a patient as desired and adaptable for placing the patient in a variety of different positions suitable for accomplishing a number of different care related tasks. If desired, the patient turning aid of the present invention can be made out of a variety of different materials, including paper, plastic or other inexpensive to make and disposable materials.

In one general aspect, the patient turning aid of the present invention is utilized to turn or otherwise assist moving a patient in a hospital-type bed having one or more side rails. In the preferred embodiment, the patient turning aid has a main body panel that is configured to support the patient and one or more elongated extension members attached to and extending outwardly from the ends of the body member. The extension members are configured to connect to the side rails of a hospital-type bed utilizing a connecting mechanism such as hook and loop material, snaps or other connectors that connect when the distal ends of the extension members loop or fold around the side rails. Preferably, the main body member and extension members are made out of flexible materials for ease of packaging, storage and use. In the preferred embodiment, the main body panel has an upper surface comprising a generally absorbent material, such as cotton and the like, and a lower surface comprising a substantially impermeable material, such as nylon, so that any fluids, including wash fluids, bodily fluids and medicines, will be absorbed by the upper layer of material and prevented from soaking or otherwise passing through to the bedding, patient or other surfaces. In an alternative embodiment, an intermediate panel is disposed between the main body panel and the extension members. The main body panel and extension members should be sufficiently strong to allow the health care assistant to use the patient turning aid to turn, pivot or raise the patient in the bed so that bedding or clothing can be changed or bandages and medicines applied without having to remove the patient from the bed. Use of the patient turning aid of the present invention allows many tasks that are typically performed by two or more persons to be performed by one person without risk of injury to the health care assistant or the patient.

In use, the patient turning aid is utilized to rotate, pivot and/or raise a patient and then hold the patient in that position while the health care assistant provides the needed care. The main body panel of the patient turning aid is positioned under the part of the patient that the health care assistant desires or needs to move. The extension members on one end of the main body panel are placed above the side rails and the extension members on the other side are placed below at least one rail of the side rails so the distal end of these extension members can be attached to the side rails. The side with extension members below one of the side rails is attached to the side rails on that side of the bed. Once attached, the health care assistant pulls on the other extension members to turn the patient towards the health care assistant. Once the patient is sufficiently turned, then the health care assistant attaches those extension members to the side rails also. Once these are attached, the health care assistant can perform the necessary tasks, such as replacing bedding, changing clothes, replacing bandages or applying creams or medicine.

Accordingly, the primary objective of the present invention is to provide an improved patient turning aid that provides the benefits described above and overcomes the disadvantages and limitations which are associated with currently available turning aids to solve the problems associated with moving and holding a patient in a desired care treating position.

An important objective of the present invention is to provide a patient turning aid that allows a single health care assistant to rotate, pivot, raise or otherwise move a patient into a desired position and then hold the patient in that position while the health care provider accomplishes the desired task, such as changing bandages, clothes or bedding.

It is also an important objective of the present invention to provide a patient turning aid that is easy to use, effective at moving or holding a patient and adaptable to moving and holding the patient in a variety of different positions.

It is also an important objective of the present invention to provide a patient turning aid that comprises a main body panel, having an absorbent upper layer and an impermeable lower layer, with one or more extension members extending outwardly from both ends to attach to one or more side rails using connecting mechanisms such as hook and loop or snaps.

The above and other objectives of the present invention will be explained in greater detail by reference to the attached figures and the description of the preferred embodiments which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a top plan view of a preferred embodiment of the patient turning aid of the present invention showing use of hook and loop connectors on the extension members;

FIG. 2 is a top plan view of an alternative embodiment of the patient turning aid of the present invention showing the use of an intermediate portion disposed between the main body panel and the extension members and the use of buckles to connect the extension members;

FIG. 3 is a top plan view of a use of the embodiment of FIG. 1, showing a patient laying on a pair of patient turning aids on a hospital-type bed;

FIG. 4 is a top plan view of a patient being turned by a health care assistant using a patient turning aid configured according to the embodiment of FIG. 1 of the present invention;

FIG. 5 is a side view of a patient turning aid configured according to the embodiment of FIG. 1 of the present invention being used to support the head of a patient in a partially upright position; and

FIG. 6 is a side view of the patient turning aid of FIG. 1.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represent one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For purposes of simplifying this disclosure, the discussion and references herein are generally to use of the present invention with a hospital-type bed having side rails on each side thereof. Those skilled in the art, however, will understand and appreciate that the patient turning aid disclosed herein is not so limited, namely that it can be used with other types of beds having adequately configured side support components.

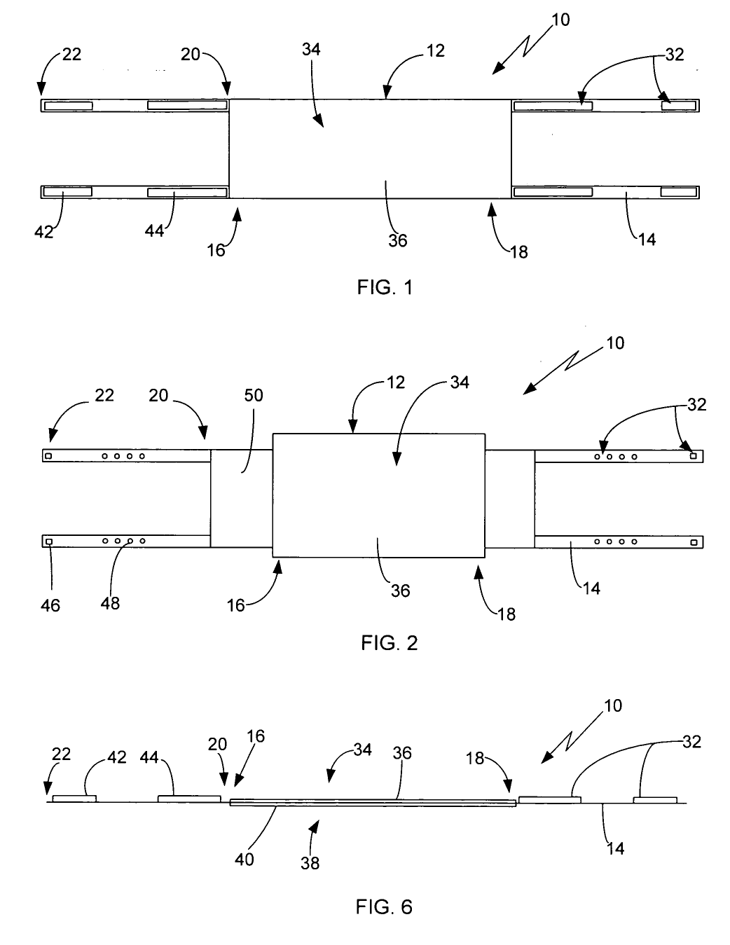

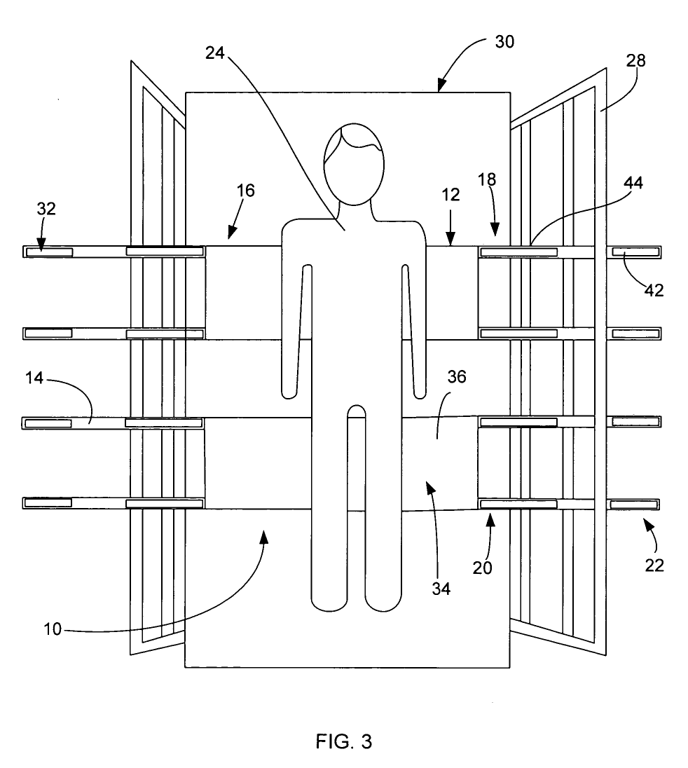

A patient turning aid that is manufactured out of the components and configured pursuant to a preferred embodiment of the present invention is shown generally as 10 in the figures. As best shown in FIGS. 1 and 2, patient turning aid 10 comprises a flexible main body panel 12 and one or more elongated extension members 14 extend outwardly from each of first end 16 and second end 18 of main body panel 12. In the preferred embodiment, shown in FIG. 1, four extension members 14 are utilized with patient turning aid 10, two extending outwardly from each of first end 16 and second end 18. In this embodiment, the proximal ends 20 of each extension member 14 attaches directly to first end 16 and second end 18 of main body panel 12 such that the distal ends 22 of each extension member 14 freely extends outwardly from main body panel 12. Those skilled in the art will readily recognize that one, two or more than two extension members 14 can be utilized at each of first 16 and second end of main body panel 12 of the patient turning aid 10 of the present invention in order to accomplish the objectives herein. As more fully described below and illustrated in FIGS. 3 through 5, main body panel 12 is used to support the patient, shown as 24, and extension members 14 are used by the health care assistant 26 to move (i.e., rotate, pivot or raise) patient 24 and to support him or her in the desired position by attaching extension members 14 to the bed rails 28 utilized with a typical hospital-type bed 30. To secure patient turning aid 10 to the bed rails 28 so as to move or hold the patient 24 in the desired position, each of the extension members 14 are provided with one or more connecting mechanisms 32 that are configured to secure extension members 14 to one of the bed rails 28 of bed 30.

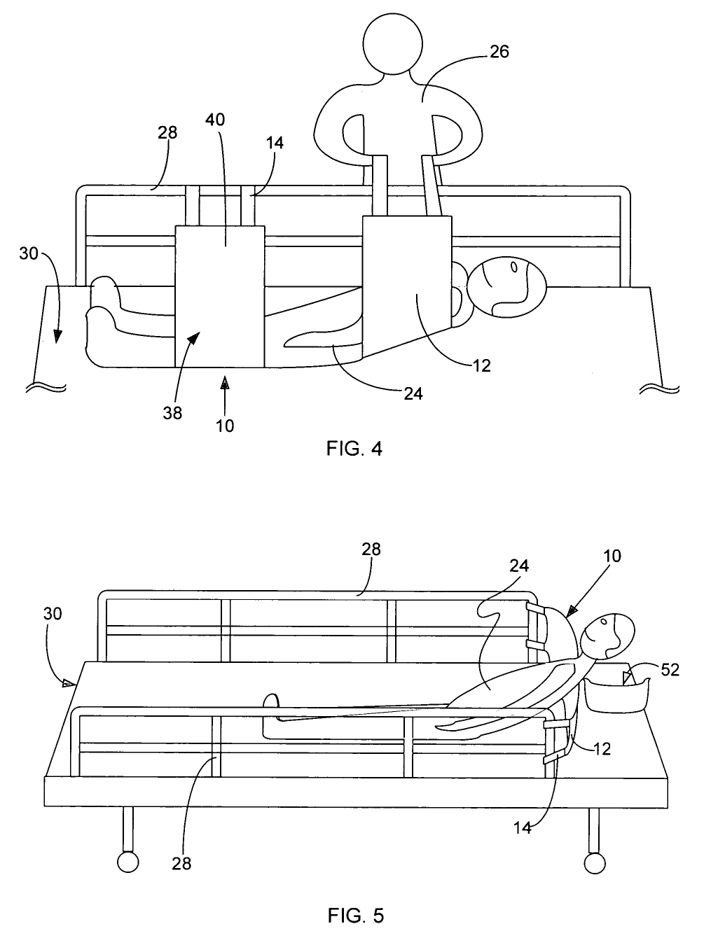

In one preferred embodiment of the patient turning aid 10 of the present invention, as best shown in FIGS. 1 and 6, main body panel 12 is a generally rectangular or square shaped component that has an upper surface 34, which is the surface on which the patient 24 lays or is placed while the health care assistant 26 uses patient turning aid 10 to assist patient 24, that comprises a first material 36. Because upper surface 34 is in contact with the body of patient 24 and may be contacted by wash fluids, bodily fluids, medicines and other fluids, it is preferred that the material for first material 36 be selected from those class of materials which are generally soft and fluid absorbent. Materials such as cotton, felt, flannel and the like, singularly or in combination, will generally be suitable materials for first material 36 used on upper surface 34 of main body panel 12. Main body panel 12 also has an opposite facing lower surface 38, best shown in FIGS. 4 and 6, that comprises a second material 40 which is preferably sized and configured to conform to the size and configuration of first material 36. Although second material 40 can be the same or functionally the same as first material 36, in the preferred embodiment second material 40 is made out of a material that is generally impermeable to fluids such that any of the fluids which contact first material 36 of upper surface 34 that are not absorbed by first material 36 will not soak, flow or otherwise pass through patient turning aid 10 to spill or soil bed 30, patient 24 or the floor. Material such as nylon and the like are generally known to be sufficiently impermeable to fluids for patient turning aid 10. The materials selected for first material 36 of upper surface 34 and second material 40 of lower surface 38 are also selected to provide a substantially flexible main body panel 12 such that health care assistant 26 can easily place patient turning aid 10 under patient 24. In addition, a flexible main body panel 12 will provide a patient turning aid 10 that is easier to pack, store and handle than one which is substantially inflexible or stiff. Naturally, any materials chosen for main body panel 12 must provide, either alone or jointly, sufficient strength to prevent main body panel 12 from tearing or otherwise coming apart during use, particularly when supporting patient 24 in a generally upright position or when health care assistant 24 is rotating or pivoting patient 24.

In the preferred embodiment of patient turning aid 10 of the present invention, elongated extension members 14 are made out of flexible and strong material that is able to wrap around bed rails 28 of bed 30 and provide sufficient tensile strength to raise, pivot and support patient 24, as shown in FIGS. 3 through 5 and described in more detail below. In a preferred embodiment, extension members 14 are made out of a nylon webbing material, which is commonly utilized as straps for packs and the like. This type of material, and materials that have similar properties, can be easily folded for packaging or storage and looped around bed rails 28 for connecting mechanisms 32 when used to assist patient 24. The proximal end 20 of extension members 14 can attach to main body panel 12 utilizing one or more suitable mechanisms and in a variety of different configurations. In the preferred embodiment, proximal end 20 of extension members 14 are fixedly attached to first 16 and second 18 ends of main body panel 12 utilizing by sewing the components together utilizing suitable thread and threaded pattern. Alternatively, extension members 14 can be made integral with or removably attached to first 16 and second 18 ends of main body panel 12. The connection between extension members 14 and main body panel 12 should be of sufficient strength that extension members 14 will not tear or otherwise separate from main body panel 12 during use.

In an alternative embodiment of patient turning aid 10 of the present invention, main body panel 12 and extension members 13 are made out of one or more disposable materials that are selected to be sufficiently strong to support patient 24 during the intended uses of patient turning aid 10. Paper, cloth and plastic are examples of materials that are generally suitable for main body panel 12. In a particularly preferred configuration of the alternative embodiment, main body panel 12 is manufactured out of a paper or paper-like material that is sufficiently thick so as not to tear or rip when moving patient 24, yet thin enough to be relatively inexpensive to make and readily disposable after use. Main body panel 12 should also be configured to be comfortable against the skin of the patient 24 or the thin hospital type gowns worn by many patients 24 so as to not cause discomfort to patient 24. Extension members 14 can be made out of the same paper, cloth or plastic materials utilized for main body panel 12 and be configured in a generally elongated strap or strap-type of configuration, as shown in the figures. The first end 20 of each extension member 14 should be securely attached to the sides 16 and 18 of main body panel 12 so that when health care assistant 26 pulls on extension members 14, as shown in FIG. 4, they do not tear away from main body panel 12. Naturally, extension members 14 should be made out of materials and be adequately sized such that they do not tear apart when pulled by health care assistant 26. If desired, main body panel 12 and extension members 14 can be made integral with each other, which may enable the manufacturer to reduce the costs of making patient turning aid 10.

As set forth above, each extension member 14 of the preferred embodiment of the patient turning aid 10 of the present invention has a connecting mechanism 32 associated therewith. Although extension members 14 can be configured to just tie to side rails 28 of bed 30, in the preferred embodiment of the present invention connecting mechanism 32 is configured such that the distal end 22 of extension members 14 is looped around or folded over one of bed rails 28 and connected to itself, as shown in FIGS. 4 and 5. In a preferred configuration, connecting mechanism 32 comprises hook and loop material, such as Velcro®. As shown in FIG. 1, the hook section 42 can be located at the distal end 22 of extension member 14 and the loop section 44 can be located towards proximal end 20 of extension member 14 such that when extension member 14 is looped or folded over bed rail 28 the hook 42 and loop 44 sections interact to secure extension member 14 to bed rail 28. Other types of connecting mechanisms 32 can be utilized with patient turning aid 10. For instance, as shown in FIG. 2, connecting mechanism 32 can comprise a snap mechanism having a first snap member 46 at the distal end 22 of extension member 14 and a plurality of second snap members 48 located towards the proximal end thereof that are configured to interact with first snap member 46 and secure extension member 14 to bed rail 28. As those skilled in the art will know, various other types of connecting mechanisms 32 can be utilized with the patient turning aid 10 and the positioning of those components can be reversed from that described above.

In an alternative configuration, patient turning aid 10 comprises an intermediate panel 50 disposed between the extension members 14 and the first 16 and second 18 ends of main body panel 12. Use of intermediate panel 50 can allow the size of main body panel 12 to be reduced, thereby reducing the amount of materials for patient turning aid 10 and, as a result, the cost of manufacturing patient turning aid 10. As set forth above, intermediate panel 50 can be made integral with main body panel 12 and extension members 14 or they can be separate components that are connected together. If the various components of patient turning aid 10 are separate components, then they need to be securely attached together to form a sufficiently strong and contiguous main body panel 12 for patient turning aid 10. As with the other components, intermediate panel 50 can be made out of the same combination of absorbent first material 36 and impermeable second material 40 utilized in the preferred embodiment of main body panel 12, or it can be made out of paper, cloth, plastic or a variety of other suitable materials described for the alternative embodiment.

In use, patient turning aid 10 is used to rotate, pivot and/or raise a patient 24 and then hold the patient 24 in that position while the health care assistant 26 provides the needed care. As shown in FIG. 3, main body panel 12 of patient turning aid 10 is placed under the part of the patient 24 desired to be moved with one side of the extension members 14 placed above the bed rails 28 and the other side below at least one of bed rails 28 so it can be attached thereto. In FIG. 3, the patient 24 is being prepared to be rolled to the right side of bed 30 (viewed from the foot of bed 30). In FIG. 4, both of the extension members 14 of one of the two patient turning aids 10 are attached to bed rail 28 and health care assistant 26 is pulling on the free extension members 14 of the other patient turning aid 10 to pivot patient 24 onto his or her side. In FIG. 5, patient turning aid 10 is being utilized to raise, and secure in a raised position, the head of patient 24 so that his or her hair may be washed utilizing the wash basin, shown as 52, that is placed below the patient's head. If desired, a pillow or other support member can be placed under the patient 24 once the patient turning aid 10 has secured the patient 24 in the desired position.

While there is shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components, whether of different shapes or not, to accomplish the objectives of the present invention.

What is claimed is:

1. A patient turning aid for turning a patient in a bed having one or more side rails, said patient turning aid comprising:
a main body panel having a first end, an opposing second end, an upper surface and a lower surface;
one or more elongated extension members at each of said first end and said second end of said main body panel, each of said extension members having a proximal end disposed toward said first end or said second end of said main body panel, each of said extension members having a distal end extending outward from said main body panel; and
means on each of said one or more extension members for removably attaching said distal end of said extension members to said one or more side rails.

2. The patient turning aid according to claim 1, wherein said main body panel is flexible and each of said one or more extension members are flexible.

3. The patient turning aid according to claim 1, wherein each of said proximal ends of said extension members are fixedly attached to said first end or said second end of said main body panel.

4. The patient turning aid according to claim 1 further comprising an intermediate panel disposed between said main body panel and each of said one or more extension members.

5. The patient turning aid according to claim 4, wherein each of said proximal ends of said extension members are fixedly attached to said intermediate panel.

6. The patient turning aid according to claim 1, wherein said distal ends of each of said extension members are configured to loop around at least one of said one or more side rails.

7. The patient turning aid according to claim 1, wherein said upper surface of said main body panel comprises a first material and said lower surface of said main body panel comprises a second material.

8. The patient turning aid according to claim 7, wherein said first material is generally fluid absorbent.

9. The patient turning aid according to claim 8, wherein said second material is generally fluid impermeable.

10. The patient turning aid according to claim 9, wherein said first material is made out of cotton and said second material is made out of nylon.

11. The patient turning aid according to claim 7, wherein said second material is generally fluid impermeable.

12. The patient turning aid according to claim 1, wherein said main body panel and each of said one or more extension members is made out of paper or plastic.

13. A patient turning aid for turning a patient in a bed having one or more side rails, said patient turning aid comprising:
a flexible main body panel having a first end, an opposing second end, an upper surface and a lower surface, said upper surface comprising a first material and said lower surface comprising a second material;
one or more flexible elongated extension members at each of said first end and said second end of said main body panel, each of said extension members having a proximal end disposed toward said first end or said second end of said main body panel, each of said extension members having a distal end extending outward from said main body panel; and
means on each of said one or more extension members for removably attaching said distal end of said extension members to said one or more side rails.

14. The patient turning aid according to claim 13, wherein said first material is generally fluid absorbent and said second material is generally fluid impermeable.

15. The patient turning aid according to claim 13, wherein said second material is generally fluid impermeable.

16. The patient turning aid according to claim 13 further comprising an intermediate panel disposed between said main body panel and each of said one or more extension members.

17. The patient turning aid according to claim 16, wherein each of said proximal ends of said extension members are fixedly attached to said intermediate panel.

18. The patient turning aid according to claim 17, wherein said distal ends of each of said extension members are configured to loop around at least one of said one or more side rails.

19. A patient turning aid for turning a patient in a bed having one or more side rails, said patient turning aid comprising:
a main body panel having a first end, an opposing second end, an upper surface and a lower surface, said upper surface comprising a first material and said lower surface comprising a second material;
one or more flexible elongated extension members, each of said extension members having a proximal end disposed toward said first end or said second end of said main body panel, each of said extension members having a distal end extending outward from said main body panel;
an intermediate panel disposed between said main body panel and each of said extension members at each of said first end and said second end of said main body member; and
means on each of said one or more extension members for removably attaching said distal end of said extension members to said one or more side rails.

20. The patient turning aid according to claim 19, wherein said first material is generally fluid absorbent and said second material is generally fluid impermeable.
